(19) United States
(12) Patent Application Publication
(10) Pub. No.: US 2006/0048178 A1
(43) Pub. Date: Mar. 2, 2006

(54) Interface for controlling service actions at a set top box from a remote control

(75) Inventors: Philip Ted Kortum, Austin, TX (US); Marc Andrew Sullivan, Austin, TX (US)

Correspondence Address: TOLER & LARSON & ABEL L.L.P., 5000 PLAZA ON THE LAKE STE 265, AUSTIN, TX, 78746, US

(73) Assignee: SBC Knowledge Ventures, L.P.

(21) Appl. No.: 10/929,888

(22) Filed: Aug. 26, 2004

(51) Int. Cl. H04N 7/16; H04N 7/14

(52) U.S. Cl. 725/2; 348/14.05

(57) ABSTRACT

A method is provided for controlling service actions at a set top box. When the method is executed, a first graphical user interface is displayed. The first graphical user interface includes a first set of soft keys. An arrangement of the first set of soft keys corresponds to an arrangement of a first set of service buttons on the remote control device. Further, the arrangement of the first set of soft keys corresponds to an arrangement of a second set of service buttons on a set top box that is responsive to one or more signals from the remote control device. Each of the first set of soft keys is linked to a corresponding service button on the remote control device. Also, each of the first set of soft keys is shaped in a corresponding manner to the corresponding service button on the remote control device.

### FIELD OF THE DISCLOSURE

The present disclosure relates to set top box interfaces.

### BACKGROUND

For years, televisions have been a staple of consumer electronics sales. As such, a large majority of households in the United States owns at least one television. Providing content to those televisions is a lucrative business and there are numerous types of television content to choose from. For example, viewers can subscribe to digital broadband television networks and digital satellite television networks in order to receive standard digital television content or high definition television content. In addition, many companies now offer digital video recorders (DVRs) that can be incorporated into standard set top boxes. A DVR can be used to record digital television content transmitted to the set top box.

Typically, each of the systems presently available to consumers include a set top box that can be connected to the content provider and coupled to a television in order to display television content. The functionality of a set top box can be controlled through a graphical user interface (GUI) that is accessible using a remote control device. Current GUIs and the corresponding remote control devices often lack consistent placement of user selection keys and as such, they are not very intuitive or user friendly.

Accordingly, there is a need for an improved method and graphical user interface for controlling service actions at a set-top box from a remote control.

### BRIEF DESCRIPTION OF THE DRAWINGS

The present invention is pointed out with particularity in the appended claims. However, other features are described in the following detailed description in conjunction with the accompanying drawings in which:

FIG. 1 is a block diagram representative of an entertainment system;

FIG. 2 is a general diagram of an embodiment of a set top box;

FIG. 3 is a general diagram of an embodiment of a remote control;

FIG. 4 is a general diagram representative of an embodiment of a graphical user interface that can be used to access movies to be broadcast via the entertainment system;

FIG. 5 is a general diagram representative of an embodiment of a graphical user interface that can be used to access photos to be displayed via the entertainment system;

FIG. 6 is a general diagram of an alternative embodiment of a remote control;

FIG. 7 is a general diagram representative of an alternative embodiment of a graphical user interface that can be used to access movies to be broadcast via the entertainment system;

FIG. 8 is a general diagram representative of an alternative embodiment of a graphical user interface that can be used to access photos to be displayed via the entertainment system;

FIG. 9 is a flow chart to illustrate operating logic that can be used to present multiple screens of a graphical user interface at a television within the entertainment system; and

FIG. 10 is a flow chart to illustrate operating logic that can be used to access movies and broadcast them via the entertainment system.

### DETAILED DESCRIPTION OF THE DRAWINGS

A method is provided for controlling service actions at a set top box using a remote control. When the method is executed, a first graphical user interface is displayed. The first graphical user interface includes a first set of soft keys. In a particular embodiment, an arrangement of the first set of soft keys corresponds to an arrangement of a first set of service buttons on the remote control device. Further, the arrangement of the first set of soft keys corresponds to an arrangement of a second set of service buttons on a set top box that is responsive to one or more signals from the remote control.

In a particular embodiment, each of the first set of soft keys is linked to a corresponding service button on the remote control device. Also, each of the first set of soft keys is shaped in a corresponding manner to the corresponding service button on the remote control device. Moreover, each of the first set of soft keys has substantially the same color as the corresponding service button on the remote control device.

Still in a particular embodiment, each of the first set of soft keys is linked to a corresponding service button on the set top box. Further, each of the first set of soft keys is shaped in a corresponding manner to the corresponding service button on the set top box. Also, each of the first set of soft keys has substantially the same color as the corresponding service button on the set top box. In an illustrative embodiment, a function associated with one of the first set of soft keys is performed when the corresponding service button is pressed at the remote control device or the set top box. The method further includes exiting the first graphical user interface and displaying a second graphical user interface. The second graphical user interface includes a second set of soft keys that are the same as the first set of soft keys.

In an illustrative embodiment, the first graphical user interface includes a ready list that includes a list of movies that are available for viewing at a television. The first graphical user interface also includes a queue list that includes a list of movies that are to be downloaded to the set top box. Further, the first graphical user interface includes an action list that includes the first set of soft keys.

In a particular embodiment, the first set of soft keys includes a generally triangle-shaped soft key labeled “play” that can be selected to play a movie from the ready list and a generally circle-shaped soft key labeled “buy” that can be selected to purchase a movie from the queue list. Further, the first set of soft keys include a generally square-shaped soft key labeled “summary” that can be selected to obtain details of a movie and a generally star-shaped soft key labeled “move up” that can be selected to move a movie on the ready list or queue list up. Also, the first set of soft keys include a generally diamond-shaped soft key labeled “move down” that can be selected to move a movie on the ready list or queue list down and a generally x-shaped soft key labeled “delete” that can be selected to delete a movie from the ready list or the queue list.

In still another particular embodiment, the second graphical user interface includes a photograph selection array that includes an array of photographs available for viewing via the set top box and an action list that includes the second set of soft keys. In a particular embodiment, the second set of soft keys includes a generally triangle-shaped soft key 506 labeled “view full” that can be selected in order to display a photograph from the photograph selection array in full screen mode and a generally circle-shaped soft key 508 labeled “edit” that can be selected to edit a photograph from the photograph selection array. Moreover, the second set of soft keys includes a generally square-shaped soft key 510 labeled “details” that can be selected to obtain detail information about a particular photograph within the photograph selection array and a generally star-shaped soft key 512 labeled “send to” that can be selected in order to send a photograph from the photograph selection array to a different device. Additionally, the second set of soft keys includes a generally diamond-shaped soft key 514 labeled “buy” that can be selected in order to purchase a photograph from the photograph selection array and a generally x-shaped key 516 labeled “delete” that can be selected in order to delete a photograph from the photograph selection array.

In another embodiment, a device for managing video content is provided and includes a housing, a broadband input connection extending from the housing, and a broadband output connection extending from the housing. Further, a numerical key pad us incorporated into the housing. The numerical key pad includes a first set of service buttons. In a particular embodiment, the device further includes a processor that includes a computer readable medium and a computer program embedded within the computer readable medium. The computer program includes instructions for displaying a graphical user interface at a display device and the graphical user interface includes a first set of soft keys that correspond to the first set of service buttons on the housing.

In yet another embodiment, a system for managing video content is provided. The system includes a display device, a remote control device, and a set top box that is coupled to the display device and is responsive to the remote control. In a particular embodiment, the remote control device includes a first set of uniquely shaped and colored service buttons. The set top box includes a housing, a broadband input connection, a broadband output connection, and a second set of uniquely shaped and colored service buttons incorporated into the housing. The second set of uniquely shaped and colored service buttons is substantially similar to the first set of uniquely shaped and colored service buttons at the remote control device. The set top box further includes a processor that is coupled to a computer readable memory and the computer readable memory includes a first graphical user interface that can be used to display multiple screens at a display device.

In still another embodiment, a method for controlling service actions at a set top box is provided. A first graphical user interface is provided and includes a first set of soft keys. Each one of a first set of service buttons on a remote control device is linked to a corresponding soft key from the first set of soft keys. Further, each one of a second set of service buttons on a set top box is linked to a corresponding soft key from the first set of soft keys. A service action corresponding to any one of the first set of soft keys is performed when any one of the first set of the service buttons is pressed at the remote control device or when any one of the second set of the service buttons is pressed at the set top box.

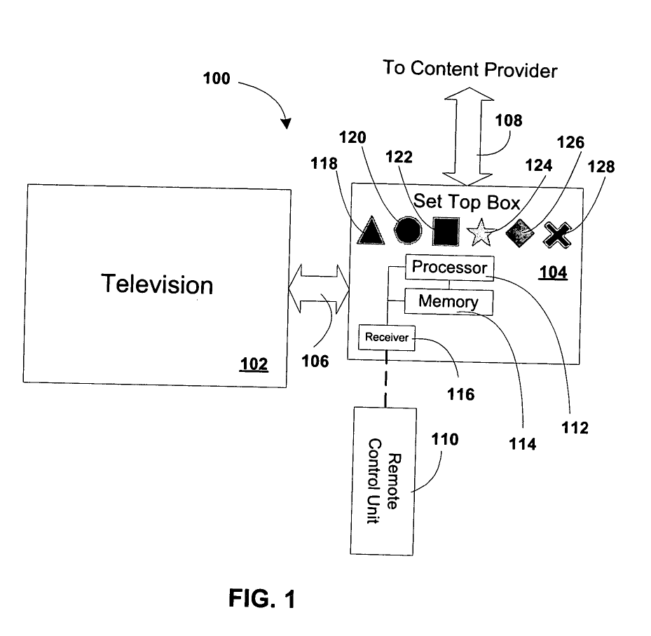

Referring to FIG. 1, a system for managing movies provided at a television is illustrated and is generally designated 100. As illustrated in FIG. 1, in an exemplary, non-limiting embodiment, the system 100 includes a television 102, but it can be appreciated that the system 100 can include any display device on which video content can be displayed. FIG. 1 indicates that a set top box 104 can be connected to the television 102 via a first broadband connection 106. The set top box 104 is also connected to a video content provider, e.g., a cable company or a digital satellite company, via a second broadband connection 108. FIG. 1 also depicts a remote control unit 110 that can communicate with the set top box 104 to allow user interaction with the system 100 during operation. The remote control unit 110 can communicate with the set top box 104 via one or more infrared (IR) signals, radio frequency (RF) signals, or other wireless signals.

As indicated in FIG. 1, the set top box 104 includes a processor 112 in which logic, such as user interface logic, can be executed. Further, the set top box 104 includes a memory 114 in which content from the content provider can be downloaded and stored. FIG. 1 also shows that the set top box 104 can include a receiver 116, e.g., an IR/RF receiver, that is configured to receive one or more IR/RF signals from the remote control unit 110.

As shown in FIG. 1, the set top box 104 can also include a plurality of service buttons that can be toggled by a user during operation. Specifically, in a particular embodiment, the set top box 104 can include a first button 118 that can be generally triangle-shaped. Further, the set top box 104 can include a second button 120 that can be generally circle-shaped. Also, in a particular embodiment, the set top box 104 can include a third button 122 that can be generally square-shaped. Moreover, the set top box 104 can include a fourth button 124 that can be generally star-shaped. The set top box 104 can also include a fifth button 126 that can be generally diamond-shaped and a sixth button 128 that can be generally x-shaped.

In an illustrative embodiment, the service buttons 118, 120, 122, 124, 126, 128 are arranged in a linear configuration on the set top box 104. Moreover, each service button 118, 120, 122, 124, 126, 128 can have a distinct color. Further, in an illustrative embodiment, the service buttons 118, 120, 122, 124, 126, 128 can correspond to a similarly shaped and colored service buttons that are located on the remote control 110 and that are presented as soft keys at the different screens of a graphical user interface (GUI) displayed at the television 102. Also, in an illustrative embodiment, the service buttons 118, 120, 122, 124, 126, 128 on the set top box are oriented in the same configuration as corresponding buttons located at the remote control and presented via the GUI.

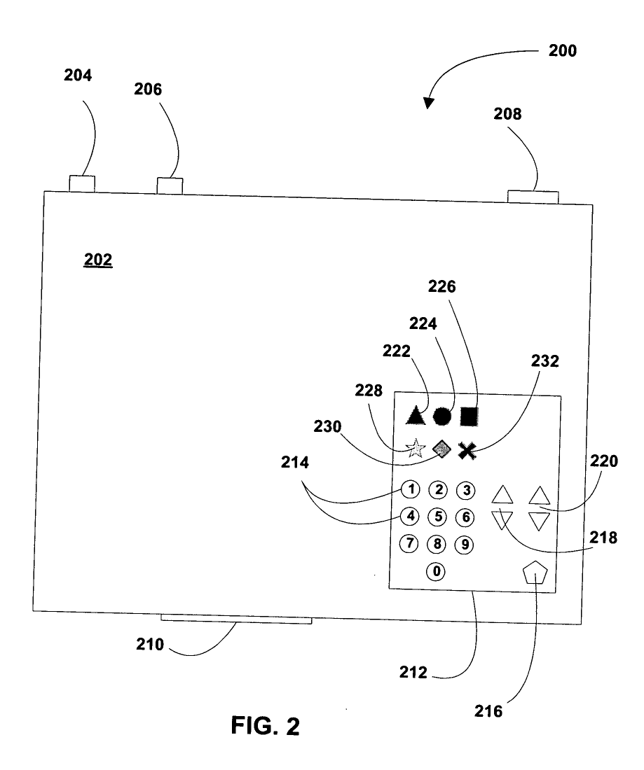

FIG. 2 shows an exemplary, non-limiting embodiment of a set top box, designated 200. As shown, the set top box 200 includes a housing 202. An input 204 and an output 206 extend from the housing 202. In a particular embodiment, the input 204 can be a broadband connection to a content provider. Moreover, the output 206 can be a connection to a television. FIG. 2 further shows a power connection 208 to which a power cord (not shown) from an external power source can be connected. As depicted in FIG. 2, the set top box 200 can further include a display 210. In an illustrative embodiment, the display 210 can be an light emitting diode display that can be used to indicate to which channel the set top box 200 the is tuned. Further the display 210 can be used to indicate the local time.

FIG. 2 indicates that the set top box 200 can include a user interface 212, e.g., a key pad. As shown, the user interface 212 includes a plurality of numbered buttons 214, e.g., from zero to nine, that can be used to tune the set top box 200 to a particular channel. Further, the user interface 212 can be include a menu or display button 216 that can be used to present a menu or display at a television connected to the set top box 200. In a particular embodiment, the set top box 200 includes two volume control buttons 218, e.g., a volume up button and a volume down button, that can be used to control the volume of the set top box 200 or another device located near the set top box 200. As illustrated in FIG. 2, the set top box 200 further includes a pair of channel control buttons 220, e.g., a channel up button and a channel down button, that can be used to move linearly, up or down, through the channels provided by the set top box 200.

In a particular embodiment, the set top box 200 includes a plurality of service buttons that correspond to soft keys that can be displayed at a television connected to the set top box 200, e.g., via a graphical user interface. Specifically, the set top box 200 can include a generally triangle-shaped first button 222, a generally circle-shaped second button 224, a generally square-shaped third button 226, a generally star-shaped fourth button 228, a generally diamond-shaped fifth button 230 and a generally x-shaped sixth button 232. As shown in FIG. 2, the numerical key pad 212 and the buttons therein are located on the top of the housing 202. However, the numerical key pad 212 can be located on the front of the housing 202, either side of the housing 202, or the back of the housing 202.

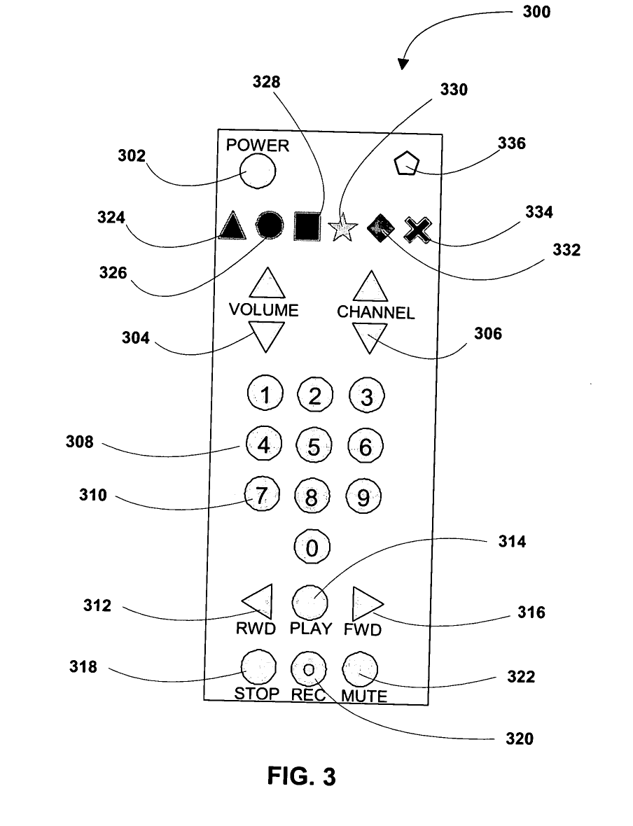

Referring to FIG. 3, an exemplary, non-limiting embodiment of a remote control device is shown and is generally designated 300. As shown, the remote control device 300 includes a power button 302 that can be used to turn the set top box 104 (FIG. 1) on and off. Moreover, the remote control device 300 includes two volume control buttons 304, e.g., a volume up button and a volume down button, that can be used to control the volume of the set top box 104 (FIG. 1) or the television 102 (FIG. 1). As illustrated in FIG. 3, the remote control device 300 further includes a pair of channel control buttons 306, e.g., a channel up button and a channel down button, that can be used to move linearly, up or down, through the channels provided by the set top box 104 (FIG. 1).

FIG. 3 also indicates that the remote control device can include a numerical key pad 308 that includes ten buttons 310 numbered from one to ten. The numerical key pad 308 can be used to input a channel number to the set top box 104 (FIG. 1). As further illustrated in FIG. 3, the remote control device 300 can include a rewind button 312, a play button 314, a forward button 316, a stop button 318, a record button 320, and a mute button 322. In an illustrative embodiment, these buttons 312, 314, 316, 318, 320, 322 can be used to control a digital video recorder (DVR) within the set top box 104 (FIG. 1), a digital video disc (DVD) player near the set top box 104 (FIG. 1), a video cassette recorder (VCR) near the set top box 104 (FIG. 1), etc.

FIG. 3 further illustrates that the remote control device 300 further includes a plurality of service buttons that are located in a portion of the remote control device 300 that is dedicated solely to the service buttons. Specifically, in a particular embodiment, the remote control device 300 can include a generally triangle-shaped first button 324. Further, the remote control device 300 can include a generally circle-shaped second button 326. Also, in a particular embodiment, the remote control device 300 can include a generally square-shaped third button 328. Moreover, the remote control device 300 can include a generally star-shaped fourth button 330. The remote control device 300 can also include a generally diamond-shaped fifth button 332 and a generally x-shaped sixth button 334. As shown in FIG. 3, the service buttons 324, 326, 328, 330, 332, 334 on the remote control device 300 are oriented in the same linear configuration as the service buttons 118, 120, 122, 124, 126, 128 (FIG. 1) on the set top box 104 (FIG. 1) and have the same spatial arrangement as the service buttons 118, 120, 122, 124, 126, 128 (FIG. 1) on the set top box 104 (FIG. 1). Moreover, each service button 324, 326, 328, 330, 332, 334 on the remote control device 300 can be the same color as the similarly shaped button 118, 120, 122, 124, 126, 128 (FIG. 1) on the set top box 104 (FIG. 1). FIG. 3 further shows that the remote control device 300 includes a menu/display button 336 that can be pressed in order to cause a graphical user interface (GUI), e.g., one of the GUIs described below, to be displayed at the television 102 (FIG. 1).

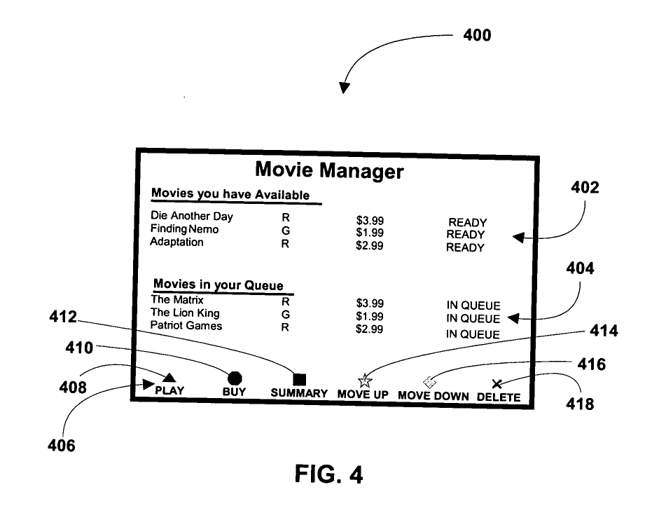

FIG. 4 depicts an exemplary, non-limiting embodiment of a graphical user interface (GUI), generally designated 400, that can be presented to a user at the television 102 (FIG. 1) during operation of the system 100. In one embodiment, the GUI 400 can include a ready list 402, a queue list 404, and an action list 406. The ready list 402 can contain a list of movie titles that correspond to video files that have been downloaded to the set top box 104 (FIG. 1), e.g., to the memory 114 (FIG. 1), and that are available to be viewed at the television 102 (FIG. 1). Moreover, the ready list 402 can include a brief description of each movie title. For example, the ready list 402 can include information concerning the rating of the movie, e.g., G, PG, R, NR, etc., the price to view the movie, and whether the movie is currently ready for viewing.

It can be appreciated that the video files corresponding to the movie titles presented by the ready list may or may not be completely downloaded to the memory 114 (FIG. 1) within the set top box 104 (FIG. 1) if streaming video is supported. If streaming video is supported by the system 100 (FIG. 1), the presence of a title in the ready list 402 may indicate that a sufficient portion of the corresponding video file has been downloaded into a buffer portion of the memory for video streaming to commence. The presence of a particular movie title can also indicate that the corresponding video file has been downloaded in its entirety to the memory 114 (FIG. 1) of the set top box 104 (FIG. 1). In an illustrative embodiment, the GUI 400 can include icons or text to indicate to a user whether a particular video file is going to be streamed or fully downloaded.

Further, in a particular embodiment, the queue list 404 can contain a list of movie titles that correspond to video files that a user wishes to see at some later date or time. The queue list 404 can also include information regarding the movie titles presented therein, e.g., ratings, prices, and download status. In an exemplary, non-limiting embodiment, the top item on the queue list 404 can be downloaded and moved to the ready list 402 when space in the ready list 402 becomes available, e.g., after a movie title has been deleted from the ready list 402 and the corresponding video file has been deleted from the memory 114 (FIG. 1). It can be appreciated that in addition to showing the movies that are to be downloaded, the queue list 404 can also serve as a wish list for a user. In other words, a user can add a number of other movie titles to the queue list 404 in order to help keep track of the movies that the user may want to view at a later time.

As illustrated in FIG. 4 and in an exemplary, non-limiting embodiment, the action list 406 can include a plurality of soft keys that a user can use to accomplish certain tasks using the remote control unit 300 (FIG. 3), e.g., by toggling one of the service buttons 324, 326, 328, 330, 332, 334 (FIG. 3) included in the remote control unit 300 (FIG. 3) or one of the service buttons 118, 120, 122, 124, 126, 128 (FIG. 1) included in the set top box 100 (FIG. 1). FIG. 4 shows that the action list 406 can include a generally triangle-shaped soft key 408 that is labeled “play”, a generally circle-shaped soft key 410 that is labeled “buy”, a generally square-shaped soft key 412 that is labeled “summary”, a generally star-shaped soft key 414 that is labeled “move up”, a generally diamond-shaped soft key 416 that is labeled “move down”, and a generally x-shaped soft key 418 that is labeled “delete”.

In a particular embodiment, the soft keys 408, 410, 412, 414, 416, 418 presented in the action list 406 have the same spatial arrangement and are oriented in the same linear configuration as the service buttons 118, 120, 122, 124, 126, 128 (FIG. 1) on the set top box 104 (FIG. 1) and the service buttons 324, 326, 328, 330, 332, 334 (FIG. 3) on the remote control device 300 (FIG. 3). Moreover, each of the soft keys 408, 410, 412, 414, 416, 418 can be the same color as each similarly shaped service button 324, 326, 328, 330, 332, 334 (FIG. 3) on the remote control device 300 (FIG. 3) and each similarly shaped button 118, 120, 122, 124, 126, 128 (FIG. 1) on the set top box 104 (FIG. 1).

Further, in a particular embodiment, the labels attached to the soft keys indicate the functionality of each soft key. For example, when the “play” soft key 408 is selected, a video file can be broadcast to the television 102 (FIG. 1), e.g., from the memory 114 (FIG. 1) in the set top box 104 (FIG. 1). The “buy” soft key 410 can be selected in order to purchase a movie in the queue list 404. Further, the “summary” soft key 412 can be selected in order to present summary information to a user, e.g., summary information about video files downloaded or video files scheduled to be downloaded. In another embodiment, these tasks can be accomplished using the correspondingly shaped and colored service buttons 118, 120, 122, 124, 126, 128 that are located at the set top box 104 (FIG. 1).

In an illustrative embodiment, the “move up” soft key 414 and the “move down” soft key 416 can be toggled, or otherwise selected, in order to navigate through the GUI 400, e.g., to select a movie title for viewing or downloading. In another embodiment, a user can highlight a movie title in the queue list 404 and then, use the “move up” soft key 414 or the “move down” soft key 416 in order to change the position of the highlighted movie title in the queue list 404. Further, the “delete” soft key 418 can be selected, e.g., to delete a movie title from the ready list 402 or the queue list 404. It can be appreciated that the action list 406 can include other keys for added functions other than those shown. For example, the action list 406 can include a browse key, a rent key, a set password key, an information key, and an exit key.

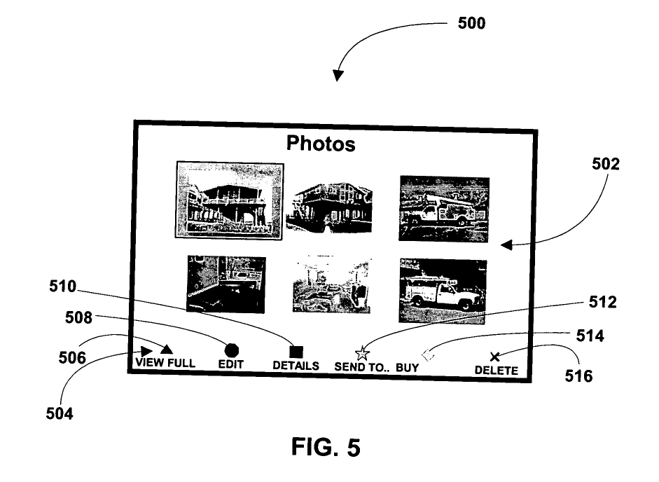

FIG. 5 depicts a GUI, designated 500, that can be used to access photographs via the set top box 104 (FIG. 1) and display them at the television 102 (FIG. 1). As shown in FIG. 5, the GUI 500 includes a photograph selection array 502 and an action list 504. The photograph selection array 502 includes an array of photographs that can be obtained using the set top box 104 (FIG. 1) and displayed at the television 102 (FIG. 1).

As illustrated in FIG. 5 and in an exemplary, non-limiting embodiment, the action list 504 can include a plurality of soft keys that a user can use to accomplish certain tasks using the remote control unit 300 (FIG. 3), e.g., by toggling one of the corresponding service buttons 324, 326, 328, 330, 332, 334 (FIG. 3) included in the remote control unit 300 (FIG. 3). FIG. 5 shows that the action list 506 can include a generally triangle-shaped soft key 506 that is labeled “view full”, a generally circle-shaped soft key 508 that is labeled “edit”, a generally square-shaped soft key 510 that is labeled “details”, a generally star-shaped soft key 512 that is labeled “send to”, a generally diamond-shaped soft key 514 that is labeled “buy”, and a generally x-shaped key 516 that is labeled “delete”.

In a particular embodiment, the soft keys 506, 508, 510, 512, 514, 516 presented by the GUI 500 are spatially arranged in the same linear configuration as the soft keys 408, 410, 412, 414, 416, 418 presented in the GUI 400 shown in FIG. 4, the service buttons 118, 120, 122, 124, 126, 128 (FIG. 1) on the set top box 104 (FIG. 1), and the service buttons 324, 326, 328, 330, 332, 334 (FIG. 3) on the remote control device 300 (FIG. 3). Moreover, each the soft keys 506, 508, 510, 512, 514, 516 can be the same color as each similarly shaped soft key 408, 410, 412, 414, 416, 418 of the GUI 400 (FIG. 4), each similarly shaped service button 324, 326, 328, 330, 332, 334 (FIG. 3) on the remote control device 300 (FIG. 3), and each similarly shaped button 118, 120, 122, 124, 126, 128 (FIG. 1) on the set top box 104 (FIG. 1).

In a particular embodiment, the labels attached to the soft keys 506, 508, 510, 512, 514, 516 indicate the functionality associated with the soft keys. For example, when the “view full” soft key 506 is selected, a photograph from the photograph selection array 502 is presented in full screen view at the television 102 (FIG. 1). The “edit” soft key 508 can be selected in order to edit a photograph in the photograph selection array 502. Further, the “details” soft key 510 can be selected in order to present detailed information to a user about a particular photograph, e.g., details concerning the contents of the photograph. In illustrative embodiment, the “send to” soft key 512 can be used to send a photograph to another location, e.g., to another set top box 104 (FIG. 1), a computer, a portable data assistant, a mobile telephone, etc. Also, the “buy” soft key 514 can be used to buy a photograph from the photograph selection array 502. In an illustrative embodiment, the “delete” soft key 516 can be used to delete a photograph from the photograph selection array 502.

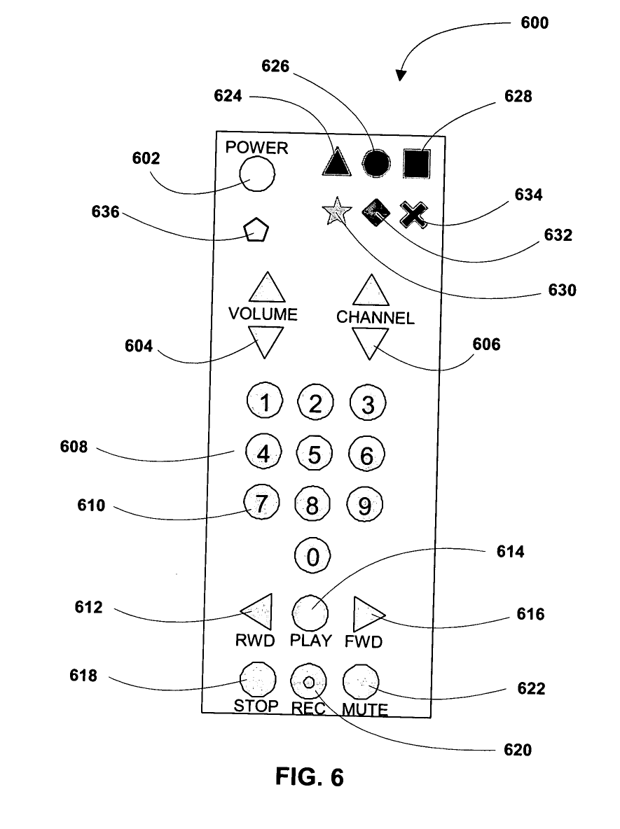

Referring to FIG. 6, an alternative embodiment of a remote control device is shown and is generally designated 600. As shown, the remote control device 600 includes a power button 602 that can be used to turn the set top box 104 (FIG. 1) on and off. Moreover, the remote control device 600 includes two volume control buttons 604, e.g., a volume up button and a volume down button, that can be used to control the volume of the set top box 104 (FIG. 1) or the television 102 (FIG. 1). As illustrated in FIG. 6, the remote control device 600 further includes a pair of channel control buttons 606, e.g., a channel up button and a channel down button, that can be used to move linearly, up or down, through the channels provided by the set top box 104 (FIG. 1).

FIG. 6 also indicates that the remote control device can include a numerical key pad 608 that includes ten buttons 610 numbered from one to ten. The numerical key pad 608 can be used to input a channel number to the set top box 104 (FIG. 1). As further illustrated in FIG. 6, the remote control device 600 can include a rewind button 612, a play button 614, a forward button 616, a stop button 618, a record button 620, and a mute button 622. In an illustrative embodiment, these buttons 612, 614, 616, 618, 620, 622 can be used to control a digital video recorder (DVR) within the set top box 104 (FIG. 1), a digital video disc (DVD) player near the set top box 104 (FIG. 1), a video cassette recorder (VCR) near the set top box 104 (FIG. 1), etc.

FIG. 6 further illustrates that the remote control device 600 further includes a plurality of service buttons. Specifically, in a particular embodiment, the remote control device 600 can include a generally triangle-shaped first button 624. Further, the remote control device 600 can include a generally circle-shaped second button 626. Also, in a particular embodiment, the remote control device 600 can include a generally square-shaped third button 628. Moreover, the remote control device 600 can include a generally star-shaped fourth button 630. The remote control device 600 can also include a generally diamond-shaped fifth button 632 and a generally x-shaped sixth button 634. FIG. 6 further shows that the remote control device 600 includes a menu/display button 636 that can be pressed in order to cause a GUI, e.g., one of the GUIs described herein, to be displayed at the television 102 (FIG. 1).

As shown in FIG. 6, the service buttons 624, 626, 628, 630, 632, 634 on the remote control device 600 are oriented in a generally rectangular configuration that corresponds to the location of plural soft keys on various screens of a GUI, described below. Moreover, each service button 624, 626, 628, 630, 632, 634 on the remote control device 600 can be the same color as similarly shaped soft keys presented via a GUI. In a particular embodiment, similar buttons on a set top box are configured in the same rectangular array.

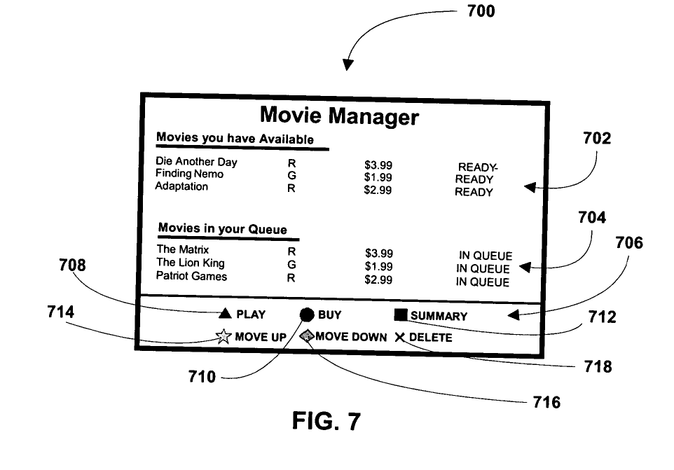

FIG. 7 depicts an exemplary, non-limiting embodiment of a graphical user interface (GUI), generally designated 700, that can be presented to a user at the television 102 (FIG. 1) during operation of the system 100. In one embodiment, the GUI 700 can include a ready list 702, a queue list 704, and an action list 706. The ready list 702 and the queue list 704 can have the same functionality as described above in conjunction with FIG. 4. Moreover, in a particular embodiment, the action list 706 can include a plurality of soft keys that a user can use to accomplish certain tasks using the remote control unit 600 (FIG. 6), e.g., by toggling one of the service buttons 624, 626, 628, 630, 632, 634 (FIG. 6) included in the remote control unit 600 (FIG. 6) or one of the service buttons 222, 224, 226, 228, 230, 232 (FIG. 2) included in the set top box 200 (FIG. 2). FIG. 7 shows that the action list 706 can include a generally triangle-shaped “play” soft key 708, a generally circle-shaped “buy” soft key 710, a generally square-shaped “summary” soft key 712, a generally star-shaped “move up” soft key 714, a generally diamond-shaped “move down” soft key 716, and a generally x-shaped “delete” soft key 718.

In a particular embodiment, the soft keys 708, 710, 712, 714, 716, 718 presented in the action list 706 are spatially oriented in the same rectangular configuration as the service buttons 624, 626, 628, 630, 632, 634 (FIG. 6) on the remote control device 600 (FIG. 6) and the service buttons 222, 224, 226, 228, 230, 232 (FIG. 2) on the set top box 200 (FIG. 2). Moreover, each of the soft keys 708, 710, 712, 714, 716, 718 can be the same color as each similarly shaped service button 624, 626, 628, 630, 632, 634 (FIG. 6) on the remote control device 600 (FIG. 6) and each similarly shaped service button 222, 224, 226, 228, 230, 232 (FIG. 2) on the set top box 200 (FIG. 2).

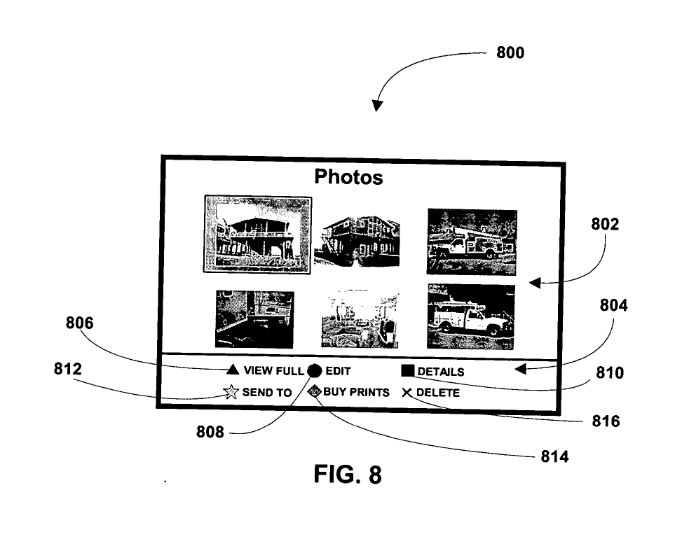

FIG. 8 depicts another embodiment of a GUI, designated 800, that can be used to access photographs via the set top box 104 (FIG. 1) and display them at the television 102 (FIG. 1). As shown in FIG. 8, the GUI 800 includes a photograph selection array 802 and an action list 804. The photograph selection array 802 includes an array of photographs that can be obtained using the set top box 104 (FIG. 1) and displayed at the television 102 (FIG. 1).

As illustrated in FIG. 8 and in an exemplary, non-limiting embodiment, the action list 804 can include a plurality of soft keys that a user can use to accomplish certain tasks using the remote control unit 600 (FIG. 6), e.g., by toggling one of the corresponding service buttons 624, 626, 628, 630, 632, 634 (FIG. 6) included in the remote control unit 600 (FIG. 6) or the service buttons 222, 224, 226, 228, 230, 232 (FIG. 2) on the set top box 200 (FIG. 2). FIG. 8 shows that the action list 806 can include a generally triangle-shaped “view full” soft key 806, a generally circle-shaped “edit” soft key 808, a generally square-shaped “details” soft key 810, a generally star-shaped “send to” soft key 812, a generally diamond-shaped “buy” soft key 814, and a generally x-shaped “delete” soft key 816.

In a particular embodiment, the soft keys 806, 808, 810, 812, 814, 816 presented in the action list 804 are oriented in the same rectangular configuration as the service buttons 624, 626, 628, 630, 632, 634 (FIG. 6) on the remote control device 600 (FIG. 6) and the service buttons 222, 224, 226, 228, 230, 232 (FIG. 2) on the set top box 200 (FIG. 2). Moreover, each of the soft keys 806, 808, 810, 812, 814, 816 can be the same color as each similarly shaped service button 624, 626, 628, 630, 632, 634 (FIG. 6) on the remote control device 600 (FIG. 6) and the service buttons 222, 224, 226, 228, 230, 232 (FIG. 2) on the set top box 200 (FIG. 2). In a particular embodiment, the soft keys 806, 808, 810, 812, 814, 816 shown in the GUI 800 have the same functionality of the soft keys 506, 508, 510, 512, 514, 516 described in conjunction with FIG. 5.

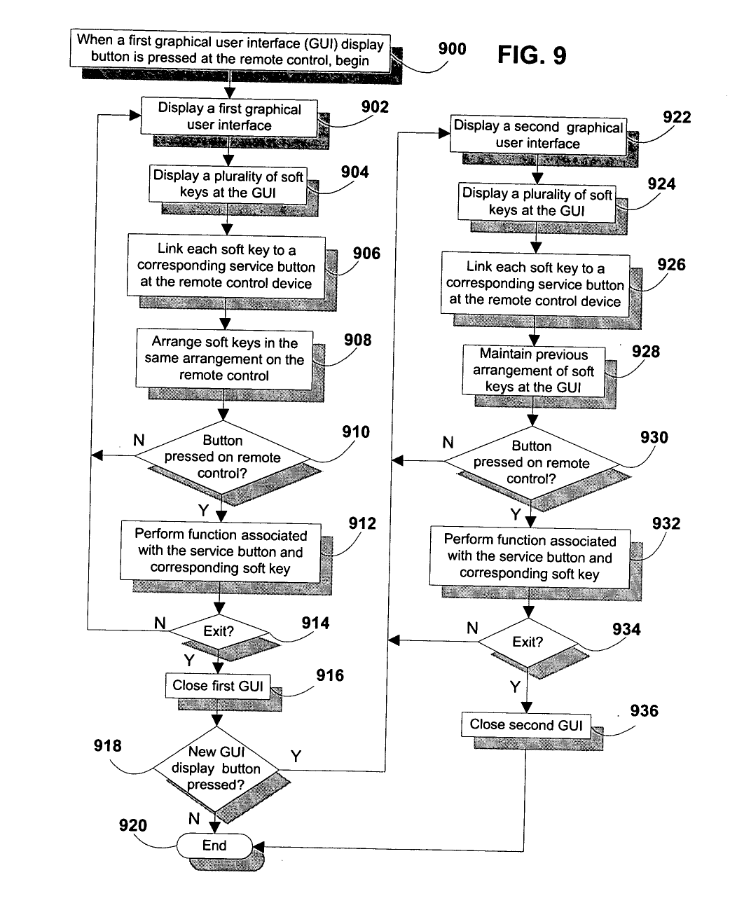

Referring now to FIG. 9, a particular embodiment of logic of the system 100 for presenting multiple screens of a GUI is shown and begins at block 900 when a first GUI display button is pressed at a remote control device, e.g., the remote control device 200 shown in FIG. 2. At block 902, a first GUI is presented to a user via the set top box 104 (FIG. 1) and the television 102 (FIG. 1). In a particular embodiment, the first GUI can be any one of the GUIs described above. Moving to block 904, a plurality of soft keys is displayed at the GUI. In a particular embodiment, the soft keys are similar to the soft keys described above.

Next, at block 906, each soft key is linked to a corresponding service button at the remote control device 200 (FIG. 2) or the set top box 104 (FIG. 1). At block 908, the soft keys are arranged at the GUI in the same spatial arrangement as the service buttons on the remote control device 200, e.g., in a linear configuration or a generally rectangle-shaped configuration. Continuing to step 91 0, a decision is undertaken in order to ascertain if one of the service buttons has been pressed at the remote control device 200. If not, the logic returns to block 902 and the first GUI continues to be displayed at the television 102 (FIG. 1). Otherwise, if one of the service buttons is pressed on the remote control device 200 (FIG. 2), the logic moves to block 912. At block 912, the function associated with the service button and the corresponding soft key displayed at the GUI is performed.

Moving to step 914, a decision is made in order to determine if the GUI is exited. The GUI can be exited by selecting an exit button, e.g., at the GUI, the remote control device 200 (FIG. 2), or the set top box 104 (FIG. 1). In an alternative embodiment, the GUI is exited automatically after a predetermined time period. If the GUI is not exited, the logic returns to block 902 and continues as described above. On the other hand, if the GUI is exited, the logic continues to block 916 and the first GUI is closed.

Proceeding to step 918, a determination is performed in order to ascertain whether another GUI display button is pressed. If not, the logic ends at state 920. If another GUI display button is pressed, the logic moves to block 922 and a second GUI is displayed. At block 924, a plurality of soft keys is displayed at the second GUI. In a particular embodiment, each soft key has the same shape and color as previously displayed. At block 926, each soft key is linked to a corresponding service button at the remote control device 200 (FIG. 2). Moreover, at block 928, the previous arrangement of the soft keys is maintained.

Proceeding to step 930, a decision is undertaken in order to ascertain if one of the service buttons has been pressed at the remote control device 200. If not, the logic returns to block 922 and the second GUI continues to be displayed at the television 102 (FIG. 1). The logic then continues as described above. At step 930, if one of the service buttons is pressed on the remote control device 200 (FIG. 1), the logic moves to block 932. At block 932, the function associated with the service button and the corresponding soft key displayed at the GUI is performed.

Next, at step 934, a decision is made in order to determine if the GUI is exited. If the GUI is not exited, the logic returns to block 922 and continues as described above. On the other hand, if the GUI is exited, the logic continues to block 936 and the first GUI is closed. The logic then ends at state 920.

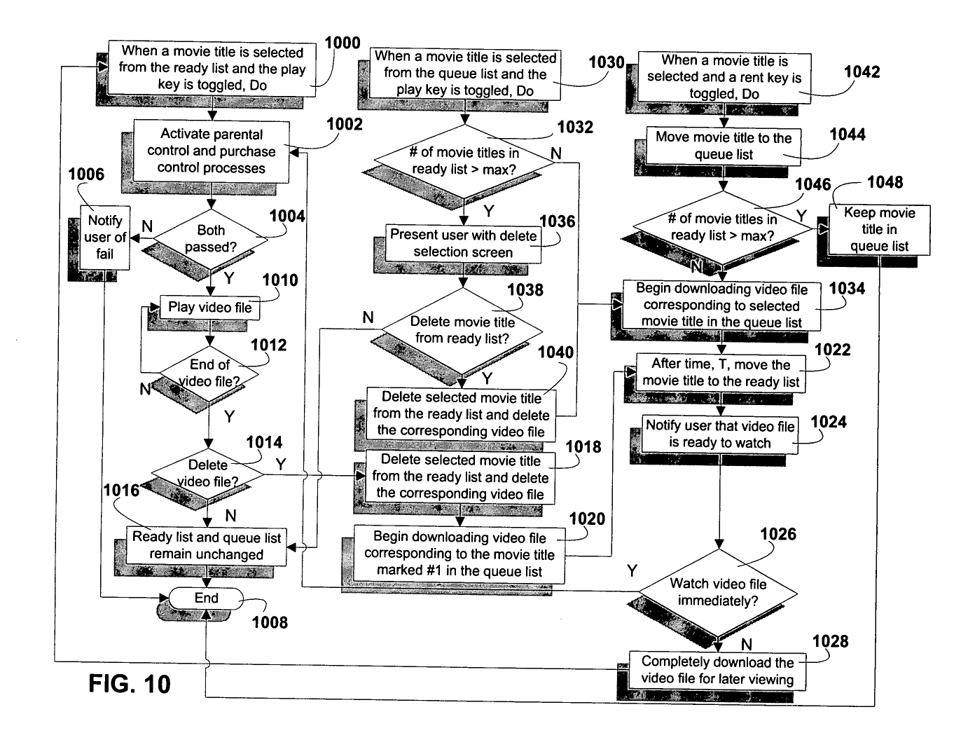

Referring to FIG. 10, a particular embodiment of operating logic of the system 100 (FIG. 1) is shown. The operating logic comprises three separate loops with several overlapping steps. Each loop is entered when certain actions are performed by the user via the GUI 400 (FIG. 4). Due to the overlap of some of the actions included in each loop, the logic will be described serially. However, after reading this specification, skilled artisans will appreciate that the loops can be entered in any particular order and the specific order of the steps described below may vary.

Commencing at block 1000, when a movie title is selected from a ready list, e.g., the ready list 402 shown in FIG. 4, and the play key 408 (FIG. 4) is toggled, the following steps are performed. At block 1002, the parental control and purchase control processes are activated. In an illustrative embodiment, these processes can require a user to input a password for each process, e.g., a parental control password and a purchase control password. Moving to decision step 1004, an action is undertaken in order to determine whether both processes have passed, e.g., has the correct password been input for both processes. If either process fails, the logic proceeds to block 1006 and the user is notified of the failure. The logic then ends at state 1008. Returning to decision step 1004, if both processes pass, e.g., a correct password has been input for both, the logic continues to block 1010 and the video file corresponding to the selected movie title is played at the television 102 (FIG. 1).

Moving to decision step 1012, an action is performed to determine whether the end of the video file is reached. If the end of the video file is not reached, the logic returns to block 1010 and the video file continues to play. On the other hand, when the end of the video file is reached, the logic moves to decision step 1014. At decision step 1014, an action is undertaken in order to determine whether the user wants to delete the video file. This action can include presenting a question to the user via a question screen (not shown) concerning deleting the movie. If the user does not want to delete the video file, the logic proceeds to block 1016 and the ready list 402 (FIG. 4) and the queue list 404 (FIG. 4) remain unchanged. However, if the user wants to delete the video file, the logic moves to block 1018 and the selected video file is deleted from the ready list 402 (FIG. 4).

Continuing to block 1020, the video file corresponding to the movie title identified as number one (1) in the queue list 404 (FIG. 4) begins downloading. At block 1022, after a predetermined time, T, or after detection of a particular event such as a completed download, the movie title is moved to the ready list 402 (FIG. 4). Proceeding to block 1024, the user is notified that the video file is ready to watch. Next, a decision is undertaken at step 1026 in order to determine whether the user wants to watch the video file immediately. This decision can be made by presenting a question to the user and receiving a user response via a GUI. If the user wants to watch the video file immediately, the logic returns to block 1002 and continues as described above. However, if the user wants to wait until a later time to watch the video file the logic moves to block 1028 and the video file is completely downloaded to the memory 114 (FIG. 1) within the set top box 104 (FIG. 1) for later viewing. The logic then proceeds to block 1000 and continues as described above.

Referring now to block 1030, when a movie title is selected from a queue list, e.g., the queue list 404 shown in FIG. 4, and the play key 408 (FIG. 4) is selected, the succeeding steps are performed. At decision step 1032, an action is undertaken in order to determine whether the number of movie titles in the ready list 402 (FIG. 4) is greater than a predetermined maximum, e.g., three movie titles. If the number of movie titles is less than the predetermine maximum, the logic continues to block 1034 and the video file corresponding to the selected movie title in the queue list 404 (FIG. 4) begins downloading. The logic then moves to block 1022 and continues as described above.

Returning to decision step 1032, if the number of movie titles in the ready list 402 (FIG. 4) is greater than the predetermined maximum, the logic moves to block 1036 where the user is presented with a delete selection screen, e.g., one of the delete selection screens described in detail below. Thereafter, an action is undertaken at decision step 1038 in order to determine whether the user wants to delete a particular movie title from the ready list 402 (FIG. 4). If not, the logic proceeds to block 1016 and continues as described above. Conversely, if the user does want to delete a particular movie title from the ready list 402 (FIG. 4), the logic moves to block 1040 and the selected movie title is deleted from the ready list 402 (FIG. 4) and the corresponding video file is deleted from the memory 114 (FIG. 1). The logic then moves to block 1034 and continues as described above.

Moving to block 1042, when a movie title is selected and a rent button is selected, the succeeding steps are performed. At block 1044, the selected movie title is moved to the queue list 404 (FIG. 4). Thereafter, a decision is performed at step 1046 in order to determine whether the number of movie titles in the ready list 402 (FIG. 4) exceeds a predetermined maximum. If not, the logic proceeds to block 1034 and continues as described above. On the other hand, if the number of movie titles in the ready list 402 (FIG. 4) does exceed the predetermined maximum, the logic continues to block 1048 where the movie title is kept in the queue list 404 (FIG. 4). The logic then ends at state 1008.

With the configuration of structure described above, the method and graphical user interface can provide a user-friendly and intuitive means for managing and viewing movies and other content via a set-top box. Moreover, the method and graphical user interface can provide added functionality with respect to the management of those movies. Additionally, the method and graphical user interface provides consistent placement of soft-keys in the various screens of the graphical user interface, on the remote control devices, and on the set top box. As such, the method and graphical user interface are relatively easy to use.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of controlling service actions at a set top box, the method comprising:
displaying a first graphical user interface, the first graphical user interface including a first set of soft keys;
wherein:
an arrangement of the first set of soft keys corresponds to an arrangement of a first set of service buttons on the remote control device; and
an arrangement of the first set of soft keys corresponds to an arrangement of a second set of service buttons on a set top box that is responsive to one or more signals from the remote control device.

2. The method of claim 1, wherein:
each of the first set of soft keys is linked to a corresponding service button on the remote control device;
each of the first set of soft keys is shaped in a corresponding manner to the corresponding service button on the remote control device; and
each of the first set of soft keys has substantially the same color as the corresponding service button on the remote control device.

3. The method of claim 2, wherein:
each of the first set of soft keys is linked to a corresponding service button on the set top box;
each of the first set of soft keys is shaped in a corresponding manner to the corresponding service button on the set top box; and
each of the first set of soft keys has substantially the same color as the corresponding service button on the set top box.

4. The method of claim 3, further comprising:
performing a function associated with one of the first set of soft keys when the corresponding service button is pressed at the remote control device.

5. The method of claim 4, further comprising:
performing a function associated with one of the first set of soft keys when the corresponding service button is pressed at the set top box.

6. The method of claim 5, further comprising:
exiting the first graphical user interface.

7. The method of claim 6, further comprising:
displaying a second graphical user interface, the second graphical user interface including a second set of soft keys.

8. The method of claim 6, wherein the second set of soft keys is the same as the first set of soft keys.

9. The method of claim 8, wherein:
an arrangement of the second set of soft keys corresponds to the arrangement of the first set of service buttons on the remote control device.

10. The method of claim 9, wherein:
each of the second set of soft keys is linked to a corresponding service button on the remote control device;
each of the second set of soft keys is shaped in a corresponding manner to the corresponding service button on the remote control device; and
each of the second set of soft keys has substantially the same color as the corresponding service button on the remote control device.

11. The method of claim 10, wherein:
the arrangement of the second set of soft keys corresponds to the arrangement of the set of service buttons on the set top box;
each of the second set of soft keys is linked to a corresponding service button on the set top box;
each of the second set of soft keys is shaped in a corresponding manner to the corresponding service button on the set top box; and
each of the second set of soft keys has substantially the same color as the corresponding service button on the set top box.

12. The method of claim 11, further comprising:
performing a set top box function associated with one of the second set of soft keys when the corresponding service button is pressed at the remote control device.

13. The method of claim 11, further comprising:
performing a set top box function associated with one of the second set of soft keys when the corresponding service button is pressed at the set top box.

14. The method of claim 1, wherein the first graphical user interface comprises:
a ready list comprising a list of movies that are available for viewing at a television;
a queue list comprising a list of movies that are to be downloaded to the set top box; and
an action list comprising the first set of soft keys.

15. The method of claim 14, wherein the first set of soft keys comprises:
a generally triangle-shaped soft key labeled “play” that can be selected to play a movie from the ready list;
a generally circle-shaped soft key labeled “buy” that can be selected to purchase a movie from the queue list;
a generally square-shaped soft key labeled “summary” that can be selected to obtain details of a movie;
a generally star-shaped soft key labeled “move up” that can be selected to move a movie on the ready list or queue list up;
a generally diamond-shaped soft key labeled “move down” that can be selected to move a movie on the ready list or queue list down; and
a generally x-shaped soft key labeled “delete” that can be selected to delete a movie from the ready list or the queue list.

16. The method of claim 7, wherein the second graphical user interface comprises:
a photograph selection array comprising an array of photographs available for viewing via the set top box; and
an action list comprising the second set of soft keys.

17. The method of claim 16, wherein the second set of soft keys comprise:
a generally triangle-shaped soft key 506 labeled “view full” that can be selected in order to display a photograph from the photograph selection array in full screen mode;
a generally circle-shaped soft key 508 labeled “edit” that can be selected to edit a photograph from the photograph selection array;
a generally square-shaped soft key 5 10 labeled “details” that can be selected to obtain detail information about a particular photograph within the photograph selection array;
a generally star-shaped soft key 512 labeled “send to” that can be selected in order to send a photograph from the photograph selection array to a different device;
a generally diamond-shaped soft key 514 labeled “buy” that can be selected in order to purchase a photograph from the photograph selection array; and
a generally x-shaped key 516 labeled “delete” that can be selected in order to delete a photograph from the photograph selection array.

18. A device for managing video content, the device comprising:
a housing;
a broadband input connection extending from the housing;
a broadband output connection extending from the housing;
a numerical key pad incorporated into the housing;
a first set of service buttons within the numerical key pad;
a processor, the processor comprising a computer readable medium and a computer program embedded within the computer readable medium, the computer program comprising:
instructions for displaying a graphical user interface at a display device, the graphical user interface comprising a first set of soft keys,
wherein:
the first set of soft keys corresponds to the first set of service buttons on the housing.

19. The device of claim 18, further comprising:
a remote control device, the remote control device comprising:
a second set of service buttons;
wherein:
the second set of service buttons corresponds to the first set of service buttons and to the first set of soft keys.

20. The device of claim 19, wherein the graphical user interface comprises:
a second set of soft keys;
wherein
the second set of soft keys is substantially similar to the first set of soft keys, the first set of service keys, and the second set of service keys.

21. The device of claim 20, wherein the first set of soft keys comprises a plurality of uniquely shaped and colored soft keys and each uniquely shaped and colored soft key corresponds to a substantially similarly shaped and colored service button within the first set of service buttons.

22. The device of claim 21, wherein each uniquely shaped and colored soft key within the first set of soft keys corresponds to a substantially similarly shaped and colored service button within the second set of service buttons.

23. The device of claim 22, wherein the second set of soft keys comprise a plurality of uniquely shaped and colored soft keys that are substantially similar to the first set of soft keys.

24. The device of claim 23, wherein an arrangement of the first set of soft keys is substantially similar to an arrangement of the first set of service keys.

25. The device of claim 24, wherein an arrangement of the first set of soft keys is substantially similar to an arrangement of the second set of service keys.

26. The device of claim 25, wherein an arrangement of the second set of soft keys is substantially similar to an arrangement of the first set of service keys.

27. The device of claim 26, wherein an arrangement of the second set of soft keys is substantially similar to an arrangement of the second set of service keys.

28. The device of claim 27, wherein the first set of soft keys, the second set of soft keys, the first set of service buttons, and the second set of service buttons are arranged in a linear configuration.

29. The device of claim 27, wherein the first set of soft keys, the second set of soft keys, the first set of service buttons, and the second set of service buttons are arranged in a rectangular configuration.

30. A system for managing video content, the system comprising:
a display device;
a remote control device, the remote control device comprising a first set of uniquely shaped and colored service buttons;
a set top box coupled to the display device and responsive to the remote control device, the set top box comprising:
a housing;
a broadband input connection;
a broadband output connection;
a second set of uniquely shaped and colored service buttons incorporated into the housing, wherein the second set of uniquely shaped and colored service buttons that are substantially similar to the first set of uniquely shaped and colored service buttons at the remote control device; and
a processor, the processor coupled to a computer readable memory, the computer readable memory comprising:
a first graphical user interface to display multiple screens at a display device.

31. The system of claim 30, wherein the computer readable memory further comprises:
a set of uniquely shaped and colored soft keys presented at each of the multiple screens of the graphical user interface, each set of uniquely shaped and colored soft keys corresponding to the first set of uniquely shaped and colored service buttons on the remote control device.

32. The system of claim 31, wherein each set of uniquely shaped and colored soft keys correspond to the second set of uniquely shaped and colored service buttons on the set top box.

33. A method for controlling service actions at a set top box, the method comprising:
displaying a first graphical user interface, the first graphical user interface including a first set of soft keys;
linking each one of a first set of service buttons on a remote control device to a corresponding soft key from the first set of soft keys;
linking each one of a second set of service buttons on a set top box to a corresponding soft key from the first set of soft keys;
performing a service action corresponding to any one of the first set of soft keys, when any one of the first set of the service buttons is pressed at the remote control device or when any one of the second set of the service buttons is pressed at the set top box.

34. The method of claim 33, further comprising:
closing the first graphical user interface; and
displaying a second graphical user interface, the second graphical user interface including a second set of soft keys.

35. The method of claim 34, further comprising:
linking each one of the first set of service buttons on the remote control device to a corresponding soft key from the second set of soft keys; and
linking each one of the second set of service buttons on the set top box to a corresponding soft key from the second set of soft keys.

36. The method of claim 35, further comprising:
performing a service action corresponding to any one of the second set of soft keys, when any one of the first set of the service buttons is pressed at the remote control device or when any one of the second set of the service buttons is pressed at the set top box.

37. The method of claim 36, wherein the first set of soft keys, the second set of soft keys, the first set of service buttons, and the second set of service buttons are arranged in a substantially similar configuration.
